(19) United States
(12) Patent Application Publication
(10) Pub. No.: US 2009/0162563 A1
(43) Pub. Date: Jun. 25, 2009

(54) ELECTROCHEMICALLY PRODUCED LAYERS FOR CORROSION PROTECTION OR AS A PRIMER

(75) Inventors: Matthias Schweinsberg, Langenfeld (DE); Bernd Mayer, Heidelberg (DE); Frank Wiechmann, Duesseldorf (DE)

Correspondence Address: HENKEL CORPORATION, 1001 TROUT BROOK CROSSING, ROCKY HILL, CT, 06067, US

(73) Assignee: HENKEL AG & CO.KGaA, Duesseldorf (DE)

(21) Appl. No.: 12/273,969

(22) Filed: Nov. 19, 2008

Related U.S. Application Data
(62) Division of application No. 11/681,122, filed on Mar. 1, 2007.
Application No. 11/681,122 is a continuation of application No. 10/275,504, filed on Jun. 9, 2003, now abandoned.

(30) Foreign Application Priority Data
May 6, 2000 (DE) 10022074.6

(51) Int. Cl. B05D 1/36

(52) U.S. Cl. 427/470

(57) ABSTRACT

A process for producing a multi-layer coating on an electrically conductive surface as a corrosion protection layer and/or as a primer for an organic coating, which is produced by (a) forming a layer of at least one inorganic compound of at least one metal A having a weight per unit area of 0.01 to 10 g/m2 by electrochemical deposition on a conductive surface from a solution containing the metal A in dissolved form, wherein the metal A is a different metal from the main component of a metal on the electrically conductive surface and the inorganic compound contains less than 20 wt % phosphate ions; and (b) forming at least one layer of an organic coating on the layer deposited in stage (a); also disclosed is a metal component comprising a coating comprising at least two layers obtainable in this manner.

This application is a divisional of Ser. No. 11/681,122 filed Mar. 1, 2007, which is a continuation of Ser. No. 10/275,504, filed Jun. 9, 2003 and claims priority of PCT/EP01/04780, filed Apr. 27, 2001, which claims priority of DE 10022074.6, filed May 6, 2000. The entire contents which are incorporated herein by reference.

A very common industrial task involves providing metallic or non-metallic substrates with a first coating, which has a corrosion-inhibiting effect and/or which constitutes a primer for the application thereon of a coating containing organic polymers. An example of such a task is the pretreatment of metals prior to lacquer coating, for which various processes are available in the art. Examples of such processes are layer-forming or non-layer-forming phosphating, chromating or a chromium-free conversion treatment, for example using complex fluorides of titanium, zirconium, boron or silicon. Technically simpler to perform, but less effective, is the simple application of a primer coat to a metal prior to lacquer-coating thereof. An example of this is the application of red lead. An alternative to “wet” processes are “dry” processes, in which a corrosion-protection or coupling layer is applied by gas phase deposition. Such processes are known, for example, as PVD or CVD processes. They may be assisted electrically, for example by plasma discharge.

A layer produced or applied in this way may serve as a corrosion-protective primer for subsequent lacquer coating. However, the layer may also constitute a primer for subsequent bonding. Metallic substrates in particular, but also substrates of plastics or glass, are frequently pretreated chemically or mechanically prior to bonding, in order to improve adhesion of the adhesive to the substrate. For example, in vehicle or equipment construction, metal or plastics components may be bonded metal to metal/plastics to plastics or metal to plastics. At present, front and rear windscreens of vehicles are as a rule bonded directly into the bodywork. Other examples of the use of coupling layers are to be found in the production of rubber/metal composites, in which once again the metal substrate is as a rule pretreated mechanically or chemically before a coupling layer is applied for the purpose of bonding with rubber.

The conventional wet or dry coating processes in each case exhibit particular disadvantages. For example, chromating processes are disadvantageous from both an environmental and an economic point of view owing to the toxic properties of the chromium and the occurrence of highly toxic sludge. However, chromium-free wet processes, such as phosphating, as a rule also result in the production of sludge containing heavy metals, which has to be disposed of at some expense. Another disadvantage of conventional wet coating processes is that the actual coating stage frequently has to be preceded or followed by further stages, thereby increasing the amount of space required for the treatment line and the consumption of chemicals. For example, phosphating, which is used virtually exclusively in automobile construction, entails several cleaning stages, an activation stage and generally a post-passivation stage. In all these stages, chemicals are consumed and waste is produced which has to be disposed of.

Although dry coating processes entail fewer waste problems, they have the disadvantage of being technically complex to perform (for example requiring a vacuum) or of having high energy requirements. The high operating costs of these processes are therefore a consequence principally of plant costs and energy consumption.

For this reason, there is a need for new coating processes for producing corrosion-protection or primer layers, which require less expenditure on apparatus than dry processes and are associated with lower chemicals consumption and a smaller volume of waste than wet processes.

It is known from the prior art that thin layers of metal compounds, for example oxide layers, may be produced electrochemically on an electrically conductive substrate. For example, the article by Y. Zhou and J. A. Switzer entitled “Electrochemical Deposition and Microstructure of Copper(I) Oxide Films”, Scripta Materialia Vol. 38, No. 11, pages 1731-1738 (1998), describes the electrochemical deposition and microstructure of copper(I) oxide films on stainless steel. The article investigates above all the influence of deposition conditions on the morphology of the oxide layers; it does not disclose any practical application of the layers.

The article by M. Yoshimura, W. Suchanek, K-S. Han entitled “Recent developments in soft solution processing: one step fabrication of functional double oxide films by hydrothermal-electrochemical methods”, J. Mater. Chem. Vol. 9, pages 77-82 (1999), investigates the production of thin films of double oxides by a combination of hydrothermal and electrochemical methods. The production of ceramic materials is given as an example of application. The article does not contain any indication as to the usability of such layers for corrosion protection or as a primer.

Electrochemical formation of an oxide layer also occurs in the processes known as anodic oxidation. The present invention differs from these in that layers of metal compounds are deposited on a substrate, wherein the metal of the metal compound constitutes substantially a different metal from that which makes up the optionally metallic substrate.

It is also known to assist the formation of crystalline zinc phosphate layers electrochemically. However, the disadvantages of phosphating (several substages, such as activation, phosphating, post-passivation; occurrence of phosphating sludge) are not overcome thereby. Electrochemical promotion of the formation of zinc phosphate layers does not fall within the scope of the present invention.

The present invention relates, in a first embodiment, to the use of a layer on an electrically conductive surface as a corrosion protection layer and/or as a primer for an organic coating, which may be obtained in a stage (a), in which a layer of at least one inorganic compound of at least one metal A having a weight per unit area of 0.01 to 10 g/m² is deposited electrochemically on the said surface from a solution containing the metal A in dissolved form wherein the metal A is a different metal from the main component of the electrically conductive surface and wherein the inorganic compound contains less than 20 wt. % phosphate ions.

The solution, which contains the metal A in dissolved form, is hereinafter designated “electrolyte”. If the salt of the metal A is dissolved in water; the conductivity of this solution is as a rule sufficient for the purpose according to the present invention. Should a non-aqueous solvent be used or the conductivity of an aqueous solution not be adequate, a conducting salt, such as tetraalkyl ammonium halide, may be added. The ions in the conducting salt are not incorporated into the layer, or are incorporated to only a minor extent, but they increase the electrical conductivity of the electrolyte.

The electrically conductive surface may be an intrinsically conductive surface, such as a metallic surface. However, the layer may also be deposited on the surface of an electrically less conductive or a non-conductive material, if suitable measures are used to make the surface electrically conductive. In the case of plastics, this may be achieved, for example, in that first of all an electrically conductive metal layer is deposited by chemical means, which then constitutes the basis for the electrochemical deposition of a compound of the metal A. A glass surface may be made electrically conductive, for example, in that it is dusted with a powder of an electrically conductive substance or a conductive layer is applied via the gas phase, for example by chemical vapor deposition (CVD). However, for the present use it is preferred for the electrically conductive surface to be a metal surface.

The inorganic compound of the metal A is deposited from a solution containing the metal A in dissolved form. The solution may be a single- or multi-component, aqueous or non-aqueous solution. Examples of non-aqueous solvents having good dissolving power with regard to suitable metal compounds are liquid ammonia, dimethyl sulfoxide or organic phosphane derivatives. Examples of a multi-component aqueous solution are water/alcohol mixtures.

The electrochemical deposition may be performed cathodically or anodically, cathodic deposition being more universally usable and therefore preferred. Deposition of the inorganic compound of at least one metal A from a corresponding solution may proceed according to two different mechanisms. On the one hand, deposition may be coupled with a change in the oxidation state of the metal A, wherein a layer of a sparingly soluble compound of the metal A, in the oxidation state modified relative to the solution, grows on the electrically conductive surface. For example, copper(I) oxide may be deposited cathodically from an aqueous solution containing copper(II) ions. Another deposition mechanism is based on the fact that electrochemical processes performed on the electrically conductive surface cause a shift in the pH in the vicinity of the surface. As a consequence of this, an inorganic compound of at least one metal A may grow on the electrically conductive surface, which is sparingly soluble under the localised pH conditions at the surface. It is not then necessary for the oxidation state of the metal A to change during the deposition process. A shift in the pH at the electrically conductive surface may be effected, for example, in that hydrogen ions are discharged, thereby causing the pH to rise locally.

Where an inorganic compound of at least one metal A is mentioned herein, it is meant that this compound has in any event to contain the metal A. However, it may additionally contain further metals B, C, etc. These further metals may be present in the solution in addition to the metal A and deposited together therewith. These other metals may, however, also be components of the electrically conductive surface and be directly incorporated into the inorganic compound of at least one metal A during formation of the layer thereof. Examples of inorganic compounds, which contain a further metal in addition to the metal A, are mixed oxides, which may belong, for example, to the spinel or perovskite structural type. Examples are titanates or niobates.

Due to ease of performability and the possibility of using water as the solvent, it is preferable for the compound deposited in stage (a) to be an oxide, which may also be a mixed oxide of various metals. However, the present use is not restricted to oxides, but additionally extends to non-oxide inorganic compounds, such as selenides, sulfides or nitrides, which may be deposited from suitable, optionally water-free solvents.

It is not essential for the purposes of the present invention, for the inorganic compound of at least one metal A to consist of a merely binary or ternary compound. Rather, this compound may also be of a more complex structure, for example by also incorporating ions or molecules from the solution into the compound. Hydrated or sulfated oxides are examples of this.

The present use does not involve pure electroplating, since an electroplated layer does not constitute an “inorganic compound” in the sense of the present invention. Rather, it is required of the layer of at least one inorganic compound of at least one metal A that at least part of the metal A is present in an oxidation state >0.

In principle, any layer of at least one inorganic compound of at least one metal A which may be electrochemically deposited and is sufficiently chemically stable to act as a corrosion-protection layer may be employed for the present use. This means that the layer provides better corrosion protection with or without lacquer applied thereto than the uncoated metal surface. For reasons of price and availability, it is preferable for the metal A to be selected from Mg, Ca, Sr, Ba, Al, Si, Sn, Pb, Sb, Bi, Ti, Zr, V, Nb, Ta, Mo, W, Mt, Fe, Co, Ni, Zn, Cu. For practical purposes, the most significant metals from this list are Al, Si, Ti, Zr, Mo, W, Mn, Fe, Co, Ni, Zn and Cu.

The electrochemical deposition may be performed potentiostatically or galvanostatically. Galvanostatic deposition is technically simpler to perform and is to therefore preferred. Layer formation preferably proceeds in that the inorganic compound is deposited on the electrically conductive surface at a potential relative to a standard hydrogen electrode of between ±0.1 and ±300 V or a current density in the range of from ±0.1 to ±10000 mA per cm² of electrically conductive surface. The procedure is preferably performed at potentials of between ±0.1 and ±100 V or at a current density of from ±0.5 to ±100 mA per cm². The signs preceding the voltage and current density express the fact that deposition may proceed cathodically or anodically. Cathodic deposition, i.e. a negative potential relative to the standard hydrogen electrode, is preferred.

It is known from the literature cited above that the morphology, chemical composition and crystal structure of the deposited layer depend on deposition conditions and thus may be influenced by the choice of conditions. For example, the above-mentioned layer parameters depend on the concentration of metal ions A and optionally further components in the solution, the flow rate of the solution relative to the electrically conductive surface, the potential established and/or the current density established. The layer characteristics may thus be deliberately modified by the choice of these parameters. Deposition is preferably performed under such conditions that the inorganic compound is deposited in X-ray crystalline form. X-ray crystalline means that the inorganic compound produces sharp X-ray reflections when subjected to an X-ray diffraction experiment. The resultant highly textured surface is particularly suitable as a primer for an organic coating.

Thorough mixing of the electrolyte and/or relative movement of the electrolyte relative to the metallically conductive surface may accelerate layer formation and influence the morphology of the layer. This may proceed in that the electrolyte is stirred or pumped around in the electrolysis vessel. In addition, the electrolyte may be thoroughly mixed and moved by blowing in a gas, in particular air.

Mention was made above of deposition at a certain potential relative to a standard hydrogen electrode. Stating a potential in this manner presupposes the use of a reference electrode located as close as possible to the electrically conductive substrate surface. However, it is simpler in practice to operate galvanostatically and to establish the desired current density by varying the terminal voltage of the electrically conductive surface as the working electrode and of any desired counter electrode. Examples of suitable counter-electrodes are those which are stable for sufficiently long periods under the selected electrolysis conditions, for example stainless steel, gold, silver, platinum, graphite or glassy carbon.

In another embodiment, the present invention relates to a process for producing a coating comprising at least two layers on an electrically conductive surface, characterised in that, in a stage (a), a layer of at least one inorganic compound of at least one metal A having a weight per unit area of 0.01 to 10 g/m² is electrochemically deposited on the electrically conductive surface from a solution containing the metal A in dissolved form, wherein the metal A is a different metal from the main component of the electrically conductive surface and wherein the inorganic compound contains less than 20 wt. % phosphate ions, and in a subsequent stage (b), at least one layer of an organic polymer is applied to the layer deposited in stage (a).

A “coating comprising at least two layers” means that, as described above, a layer of at least one inorganic compound of at least one metal A is applied to the electrically conductive surface and at least one layer of an organic polymer is in turn applied to the said first layer. It goes without saying that a plurality of different layers of organic polymers may be applied to the layer of an inorganic compound. This is known from automobile construction, for example, in which, according to the prior art, at least three different layers of organic polymers are generally applied to the phosphate layer serving as inorganic corrosion-protection layer and coupling layer. These layers may comprise an electrocoating lacquer, a filler and a topcoat, for example.

The layer of at least one inorganic compound of at least one metal A may consist of a layer, the formation, properties and composition of which have been described above.

In an embodiment of substage (b) of the present process for producing a coating comprising at least two layers, a cathodically or anodically depositable electrocoating lacquer may be applied. However, this presupposes that the layer is sufficiently electrically conductive for an electrocoating lacquer to be deposited. This is the case, for example, with a layer of copper(I) oxide having a weight per unit area lower than g/m².

In this embodiment, rinsing with water is preferably performed between deposition of the layer of inorganic compound and application of the electrocoating lacquer. The said rinsing may comprise immersion or spraying. It may be advantageous to rinse using low-salt or completely deionised water, at least in the last rinsing stage. Chemical post-passivation of the inorganic layer prior to electrocoating, as is generally performed ill the case of phosphating for example, is not necessary in the present process.

In a further embodiment, the present process is performed as a coil process. In this case, in substage (b) an organic polymer layer is applied by dipping or spraying or by applicator rolls. A coil process implicitly presupposes a non-rigid substrate, such that this process variant is preferably performed using metal strips. The process preferably proceeds continuously. The electrochemical layer formation in substage (a) and the application of the organic polymer layer in substage (b) are thus performed on a moving strip.

The application of an organic polymer layer to a moving strip is known in the prior alt as the “coil coating process”. The coating installations used therefor are also suitable for the present process. The organic polymer layer may exhibit different thicknesses and different functions, for example it may be only a few μm thick and serve as a forming aid and/or as a primer for a subsequent lacquer coating. In such a case, the composition and layer thickness of the primer are preferably so adjusted that electric resistance welding is still possible. In addition, it may preferably be possible to apply an electrically depositable dip coating to the primer. Such organic primer layers on a chemically produced inorganic layer on a metal surface are known in the art by various trade names, depending on function and composition. Examples are Durasteel® and Granocoat®.

While, in the case of the above-described primer layers, the layer thickness is below 10 μm and amounts for example to 6 to 9 μm, in the coil coating process a thicker organic lacquer coating may also be directly applied, to which no subsequent lacquer coating is applied. The layer thicknesses are then from 50 to 200 μm.

In addition, a powder coating may be applied as the organic polymer in substage (b).

To this end, the inorganic layer on the electrically conductive surface need no longer be as electrically conductive as is required for subsequent electrocoating. A powder coating is preferably applied to shaped articles which are not exposed to any marked degree of corrosion. Examples thereof are articles such as household equipment or electronic apparatus stored in enclosed spaces.

The organic layer applied in substage (b) may also be an adhesive layer. The inorganic layer of at least one metal A then serves as a coupling layer between adhesive and the metallically conductive substrate. For this embodiment of the process in particular, the metallically conductive substrate may consist not only of metal itself, but also of surfaces of plastics or glass which have been made electrically conductive. Therefore, the inorganic layer may act as a coupling layer between one of the substrates metal, plastics or glass and an adhesive, wherein the adhesive may be used to join together either similar or different substrates. Examples may be found in the construction of vehicles, aircraft or household equipment, where metals are adhered to each other or to plastics or glass. Bonding of plastics to plastics is also feasible. In particular, glass panels may be bonded to vehicle bodywork in this way.

In a particular embodiment, an adhesive is applied in substage (b) with which a vulcanised or non-vulcanised rubber part is joined to a metal part. The resultant component is generally designated a “rubber/metal composite”. As a rule, a non-vulcanised rubber part is joined by an adhesive to the metallic substrate via the inorganic layer serving as a coupling layer and then vulcanised through a temperature increase, frequently with the simultaneous exertion of pressure. Such process stages are familiar in the art, wherein the metallic substrate is not coated electrochemically with a layer of an inorganic compound, however, but rather is subjected either to only mechanical or also to wet-chemical pretreatment.

Furthermore, the present invention relates in a further embodiment to a metal component the surface of which bears a coating comprising at least two layers, which coating may be obtained in one of the ways described above. The said metal component may comprise, for example, vehicles or vehicle parts, household equipment, housings for electronic apparatus, furniture or architectural parts. Preferred materials for the metal components are iron, zinc, aluminum, magnesium and alloys, of which more than 50 atom % is one of these elements. Metals and alloys may be selected which are currently conventionally used for the above-mentioned metal components.

In a preferred embodiment, the above-described metal component bears the inorganic compound of at least one metal A in X-ray crystalline form. X-ray crystalline means that the inorganic compound produces sharp X-ray reflections when subjected to an X-ray diffraction experiment.

The advantages of the present use and of the present process are in particular that the thickness, composition and internal and external structure of the inorganic layer may be more readily controlled by the selection of the deposition parameters than when the process is performed purely chemically. Fewer process stages are required for application of the layer than in the case of phosphating and in general less sludge arises than in the case of purely chemical layer formation. In comparison with gas phase deposition processes, electrochemical deposition is faster and associated with less expenditure on equipment and lower energy consumption. Moreover, it is not necessary to prepare volatile starting compounds, as with gas phase deposition.

Another advantage of electrochemical layer formation is that growth of the layer may be controlled by means of the electrical resistance at the metallically conductive surface. Provided that the growing layer exhibits higher electrical resistance than the electrically conductive surface, which is generally the case, layer growth slows down when the electrical resistance becomes too high owing to layer formation. While there are points on the metallic conductive surface which are still uncoated or the layer is still thin enough for a current still to flow at the set voltage, layer growth occurs at these points. If the metallically conductive surface is covered virtually completely with a layer of such a thickness that the electrical resistance rises markedly, the process of layer formation may be stopped. In the case of galvanostatically controlled layer growth, virtually complete layer formation is revealed by a marked increase in terminal voltage. The process may then be automatically terminated when the terminal voltage reaches a preselected value.

### EXAMPLE

Cathodic Deposition of Copper(I) Oxide on Steel from an Aqueous Solution

A pilot corrosion protection process was performed on cold-rolled steel by means of cathodic deposition Cu²O without an active stage (shortening of the process sequence). The following process parameters were set:

Cleaning: weakly alkaline (Ridoline® 1559, 2.5%, 75° C., 5-10 min)
Rinsing: tap water, deionised water

### Activation: NONE

### Conversion:

Electrolyte: 0.4 M CuSO₄+3M lactic acid, pH 10, 60° C., stirred at 400 revolutions per minute

Deposition both potentiostatically (0.2 V v. standard hydrogen electrode) and galvanostatically (−0.8 to −2.6 mAcm²)
Treatment time: 10-300 seconds
Post-rinsing: deionised water

### Drying: Compressed air

Characterisation: scanning electron microscopy, X-ray photoelectron spectroscopy, corrosion test (climate condition test)
Lacquer coating: cathodic dip coat ED 5000

The layers formed are continuous after a treatment time of about 50 seconds and consist of fine (<1 μm) crystallites of Cu²O.

The layer properties are very easy to determine owing to the electrochemical nature of the process, even without interfering with the electrolyte composition. Thus, for example, the layer thickness at a constant total current may be precisely determined by the total charge which has passed. e.g. for i=−800 mA:

| Process time | Layer weight |
|---|---|
| (Seconds) | (gm⁻²) |
| 10 | 0.4 |
| 30 | 0.7 |
| 60 | 1.1 |
| 120 | 2.4 |
| 300 | 5.6 |

In corrosion tests (10 cycles of VDA climatic condition test, cathodic dip coating), a marked improvement in corrosion protection is revealed by the coating as a function of the thickness of the layer applied:

| Process time | Climatic condition test: |
|---|---|
| (Seconds) | Creepage U/2 (mm)*⁾ |
| 10 | 4.8 |
| 30 | 4.5 |
| 60 | 3.9 |
| 120 | 3.6 |
| 300 | 2.6 |

*⁾half scribe width

1.-15. (canceled)

16. A process for producing an at least two-layer coating on an electrically conductive surface of an article which comprises:
a) depositing on an electrically conductive surface, a chromium-free layer of at least one X-ray-crystalline inorganic compound of at least one metal A, with a weight per unit area of 1.1 to 10 g/m², by electrochemical deposition from a solution containing the metal A in dissolved form, the metal A being a metal different from a main metal component of the electrically conductive surface, the at least one metal A being selected from the group consisting of Mg, Ca, Sr, Ba, Si, Sn, Pb, Sb, Bi, Ti, Zr, Nb, Ta, Mn, Fe, Co, Ni, Cu, wherein the inorganic compound contains less than 20% by weight of phosphate ions; and
b) forming at least one layer of an organic coating by at least one method selected from the group consisting of cathodic electrocoating, anodic electrocoating and powder coating on the layer deposited in step a).

17. The process as claimed in claim 16 wherein the inorganic compound deposited in step a) is an oxide.

18. The process as claimed in claim 16 wherein the inorganic compound is deposited on the electrically conductive surface at a potential against a standard hydrogen electrode of ±0.1 V to ±300 V or at a current density of ±0.1 mA per cm² to ±10,000 mA per cm² of the electrically conductive surface.

19. The process as claimed in claim 17 wherein the inorganic compound is titanium dioxide deposited on the electrically conductive surface at a potential against a standard hydrogen electrode of ±0.1 V to ±300 V or at a current density of ±0.1 mA per cm² to ±10,000 mA per cm² of the electrically conductive surface.

20. The process of claim 16 wherein the main metal component is selected from the group consisting of iron, zinc, aluminum and magnesium and the at least one metal A being a metal different from said main metal component is selected from the group consisting of Al, Si, Ti, Zr, Mo, W, Mn, Fe, Co, Ni and Zn.

21. The process of claim 17 wherein the at least one metal A is selected from the group consisting of Al, Si, Ti, Zr, Mo, W, Mn, Fe, Co, Ni and Zn.

22. The process of claim 18 wherein the at least one metal A is selected from the group consisting of Al, Si, Ti, Zr, Mo, W, Mn, Fe, Co, Ni and Zn.

23. The process of claim 18 wherein the potential against the standard hydrogen electrode is from ±0.1 V to ±100 V.

24. The process of claim 18 wherein the current density is from ±0.5 mA per cm² to ±100 MA per cm².

25. The process of claim 16 wherein the article is rinsed with water between step a) and step b).

26. The process of claim 16 wherein the article is a non-rigid metal strip and steps a) and b) are performed as a continuous coil process.

27. The process of claim 16 wherein the article is comprised of at least one of glass and plastic in addition to said main metal component.

28. The process of claim 16 wherein the solution is an aqueous solution.

29. The process of claim 16 wherein the solution is a non-aqueous solution.

30. The process of claim 16 wherein the electrochemical deposition is performed cathodically or galvanostatically.

31. The process of claim 16 wherein the main metal component is selected from the group consisting of iron, zinc, aluminum and magnesium.

32. The process of claim 31 wherein the article is a non-rigid metal strip and steps a) and b) are performed as a continuous coil process.

33. A process for providing a layer of at least one inorganic titanium compound on an electrically conducting surface which comprises:
electrochemically depositing on an electrically conducting surface, from a solution containing titanium in dissolved form, a layer comprising at least one inorganic titanium compound, the layer having a weight per unit area of from 0.01 to 10 grams/meter², wherein the electrically conducting surface comprises an electroconductive material different from titanium as the main component and wherein the at least one inorganic titanium compound contains less than 20 wt. % phosphate ions whereby a corrosion inhibiting layer or tie layer for an organic coating is formed.

34. The process as claimed in claim 33 wherein the at least one titanium compound is an oxide.

35. The process as claimed in claim 33 wherein the titanium compound is deposited on the electrically conductive surface at a potential against a standard hydrogen electrode of ±0.1 V to ±300 V or at a current density of ±0.1 mA per cm² to ±10,000 mA per cm² of the electrically conductive surface.

36. The process of claim 35 wherein the potential against the standard hydrogen electrode is from ±0.1 V to ±100 V.

37. The process of claim 35 wherein the current density is from ±0.5 mA per to ±100 MA per cm².

38. The process of claim 33 comprising an additional step of rinsing the article with water after electrodepositing said layer.

39. The process of claim 33 comprising an additional step of applying at least one layer comprising an organic polymer to said layer of said titanium compound.

40. The process of claim 33 wherein the solution is an aqueous solution.

41. The process of claim 33 wherein the solution is a non-aqueous solution.

42. The process of claim 33 wherein the electrochemical deposition is performed cathodically or galvanostatically.

43. The process of claim 33 wherein the main metal component is selected from the group consisting of iron, zinc, aluminum and magnesium.
